(19) United States
(12) Patent Application Publication
(10) Pub. No.: US 2004/0098327 A1
(43) Pub. Date: May 20, 2004

(54) Contingent convertible securities instrument and method of providing, trading and using the same

(76) Inventor: David A. Seaman, Short Hills, NJ (US)

Correspondence Address: DICKSTEIN SHAPIRO MORIN & OSHINSKY LLP, Michael J. Scheer, 41st Floor, 1177 Avenue of the Americas, New York, NY, 10036-2714, US

(21) Appl. No.: 10/293,491

(22) Filed: Nov. 14, 2002

(51) Int. Cl. G06F 17/60

(52) U.S. Cl. 705/36

(57) ABSTRACT

A contingent convertible financial instrument which includes a bond portion and an embedded option portion. The bond portion is redeemable at a maturity date similar to a traditional bond. The embedded option portion is exercisable, within a specified time period after the value of the shares of stock reaches a target value, for shares of stock in the entity issuing the bond portion in an amount equal to the difference between an early exercise value and a value of the stock on the date that the embedded option portion is exercised. In contrast to traditional convertible bonds, the exercising of the embedded option portion does not extinguish the bond portion. Methods of providing, trading and using such a convertible financial instrument are also described.

### FIELD OF THE INVENTION

The present invention relates to contingent convertible securities instruments and methods of providing trading platforms therefor. More particularly, the present invention relates to contingent convertible bonds which include an embedded option that allows the holder of the instrument to exercise the embedded option without extinguishing the underlying bond.

### BACKGROUND OF THE INVENTION

Corporations typically need to borrow capital for a wide range of expenses. The problem that corporations run into is that very few banks can afford to lend hundreds of millions of dollars to one single corporation. A solution to this problem is to issue bonds and other debt instruments in a public market, where hundreds of people lend a smaller portion of capital to the issuer of the bond until the issuer gets their desired amount of capital. These bonds are known as debt instruments. One type of debt instrument is called a contingent debt instrument: it has at least one contingent (not fixed) payment.

A purchaser of a bond, however, does not loan their money to the bond issuing corporation for free. The corporation must typically pay the purchaser a premium or “coupon” at a pre-determined interest rate in exchange for using the purchaser's money. These interest payments are usually made every six months until maturity of the bond. There are some exceptions to this such as zero coupon bonds which instead give the purchaser a large lump-sum payment once the bond has reached maturity. Contingent payment debts have coupons or principal redemptions contingent on various factors.

Contingent debt instruments with equity price contingencies are divided into two basic categories, convertibles and exchangeables. A convertible bond is a bond which can be converted into shares of the corporation issuing the bond at the option of the bondholder from the initial purchase date of the bond. It is typically not in the bondholders interest to convert the bond into shares of stock soon after purchase because the value of the bond is initially more than the value of the number of shares of stock into which it can convert. In traditional convertible bonds, once the conversion is exercised, the underlying bond is extinguished. Also, early conversion of the bond truncates the tax benefits associated with issuing the bond. An exchangeable bond differs only in that the bond is exchangeable for shares in a corporation other than the corporation issuing the bond.

FIG. 1 illustrates the conversion of a traditional convertible bond 10. At issuance, the bond 10 includes an option portion 12 and a bond portion 14. Once the bond is converted, the bond is extinguished in exchange for the gross number of shares. This is akin to a) the option portion 12 is converted into the number of shares required to settle the “in-the-money” portion of the option (e.g., the difference between the option price and the current price of the stock) and b) the bond portion 14 is converted into the remaining number of shares equivalent to the value of the bond. As seen in this Figure, the conversion of the bond extinguishes the bond portion 14, and the holder is left with only stock.

Most convertible bonds have several additional features, common ones being call option permitting the issuer to redeem the bonds at a fixed price after some future, fixed date (hard call provision) or a call option permitting the issuer to redeem the bonds at any time if the shares reach a certain price, typically 130 or 140% of the initial conversion price (soft call provision). The call option will effectively force all bondholders to effect their conversion/exchange (i.e. so as to receive the benefit of the stock price increase) rather than receive the contractual redemption amount. Again, the exercise of the call of the convertible bond totally extinguishes the underlying bond. This is called a forced conversion. When a bond is converted to common stock, the corporate debt is reduced and the corporation saves the value of paying the coupons. However, converting the debt (bonds) into stock (equity) has the effect of diluting the equity of the corporation issuing the bonds.

Also, a put option which allows the holder of the bond to choose to have the bonds redeemed at a pre-determined price and time in the future is common. Similar to the call option, exercising the put option also totally extinguishes the underlying bond, and the exercising of the put truncates the tax benefits for the issuer of the bond.

### BRIEF SUMMARY OF THE INVENTION

In order to overcome the deficiencies of the prior art, one aspect of the instant invention is directed to a contingent convertible financial instrument which includes a bond portion and an embedded option portion. The bond portion is a fixed income portion redeemable at a maturity date. The embedded option portion has an early exercise value, an initial stock value and a target value greater than the initial stock value. The embedded option portion is exercisable for shares of stock in the entity issuing the bond portion in an amount equal to the difference between the early exercise value and the value of the stock on the date that the embedded option portion is exercised within a specified time period after the value of the shares of stock reaches the target value. The exercising of the embedded option portion does not extinguish the bond portion as with traditional convertible bonds.

According to another aspect of the instant invention, a method of providing a contingent convertible financial instrument, includes issuing a bond having an embedded option. The embedded option has an early exercise value, an initial stock value and a target value greater than the initial stock value. The method further includes receiving payment in return for issuance of the bond. The embedded option is exercisable for shares of stock in the entity issuing the bond in an amount representing the difference between the early exercise value and the value of the stock on the date that the embedded option portion is exercised within a specified time period after the value of the shares of stock reaches the target value. Exercising of the embedded option does not extinguish the bonds as in a normal conversion.

According to yet another aspect of the instant invention, a method of trading a contingent convertible financial instrument, includes providing a trading platform for a bond having an embedded option. The embedded option has an early exercise value, an initial stock value and a target value greater than the initial stock value. The method further includes facilitating a trade of the bond on behalf of the entity issuing the bond, and receiving a fee for the trade. The embedded option is exercisable for shares of stock in the entity issuing the bond in an amount representing the difference between the early exercise value and the value of the stock on the date that the embedded option portion is exercised within a specified time period after the value of shares of stock reaches the target value. The exercising of the embedded option does not extinguish the bonds as in a normal conversion.

According to still another aspect of the instant invention, a method of using a contingent convertible financial instrument, includes purchasing a bond having an embedded option. The embedded option has an early exercise value, an initial stock value and a target value greater than the initial stock value. The method further includes exercising the embedded option for shares of stock in the entity issuing the bond in an amount representing the difference between the early exercise value and the value of the stock on the date that the embedded option portion is exercised within a specified time period after the value of the shares of stock reaches the target value. The exercising of the embedded option does not extinguish the bonds as in a normal conversion.

The present invention, through the use of the embedded option, provides a contingent convertible financial instrument that allows the issuer to receive anticipated tax benefits not available to traditional convertible securities that allow only full conversion and thus extinguishment of the bond. Further, the embedded option allows the purchaser to retain the benefits of the underlying bond until the maturity date while also allowing the purchaser to realize a benefit if the stock price reaches a target value.

In one embodiment of the invention, the option is not callable by the issuer of the bond, except in very limited, clearly defined instances. A further feature of the present invention is that net settlement is employed for conversion of the embedded option. Net settlement means that the option is extinguished for a smaller number of shares than a traditional convertible bond, but in contrast to traditional convertibles, the bond is not extinguished and remains outstanding until maturity.

The contingent convertible bond of the present invention has clear tax advantages for the issuer in that the issuer is able to deduct a higher rate of interest payments in comparison to the interest deductions allowed for conventional convertible bonds, and all such deductions do not end with the net exercise of the embedded option as with a full conversion. In addition to the tax benefits, the bond of the present invention is attractive to the bond holders as the un-extinguished bond receives preferential treatment in bankruptcy (as opposed to the treatment of a shareholder after conversion of a traditional convertible bond) and the combination of remaining bond value plus net settlement shares may be greater than the value they would redeem in a total conversion.

Other features and advantages of the present invention will become apparent from the following description of the invention which refers to the accompanying drawing.

### BRIEF DESCRIPTION OF THE DRAWING

For the purpose of illustrating the invention, there is shown in the drawing a form which is presently preferred, it being understood, however, that the invention is not limited to the precise arrangement shown.

FIG. 1 illustrates the conversion of a prior art convertible bond.

FIG. 2 illustrates the net settlement feature of the financial instrument of the present invention.

FIG. 3 is a graph representing the happening of a trigger event during the life of a convertible financial instrument according to an example of the present invention.

FIG. 4 is a graph showing the early exercise value by year across the life of a convertible financial instrument according to an example of the present invention.

### DETAILED DESCRIPTION OF THE INVENTION

The present invention is directed to a contingent convertible financial instrument which includes a bond portion and an embedded option portion. The bond portion is a fixed income portion redeemable at a maturity date. The bond portion, similar to standard bonds, has a par value upon initial issuance and redemption value due upon a maturity date. The financial instrument according to the present invention, however, also includes an embedded option portion. The embedded option portion is an option which is exercisable by the holder of the bond for shares of stock in the entity issuing the bond portion in an amount equal to the difference between an early exercise value and the value of the stock on the date that the embedded option portion is exercised within a specified time period after the value of the shares of stock reaches the target value. In other words, once the value of the shares of stock reaches the target value, a specified time period is set for exercising the embedded option portion, and the amount of stock received for exercising the embedded option portion is equal to the difference between the early exercise value and the value of the shares of stock on the date that the embedded option portion is exercised. The target value is typically greater than the initial stock value. Preferably, the target value of the embedded option portion is established by calculating a barrier level and applying that barrier level over the life of the bond. Preferably, the target value represents a particular stock price (although variations could include target values referenced to traded bond values).

The unique embedded option portion replicates the economics of a traditional convertible debt instrument, but provides distinct tax advantages over both traditional convertible debt instruments and contingent convertible debt instruments. At issuance, the contingent convertible bond according to the present invention functions mechanically similar to a traditional debt instrument. However, should the stock price appreciate to the point where it reaches the target value and the embedded option portion is exercised, the bond settles the value of the embedded option in a unique manner. Prior to this event, early exercise or conversion is generally prohibited.

In one embodiment of the present invention, upon the exercising of the embedded option portion, the bond according to the present invention settles the embedded option portion for the net amount of the difference between the early exercise value and the value of the stock at the time of the exercise, and extinguishes only the embedded option portion. Therefore, the embedded option portion is extinguished in return for a smaller number of shares than a traditional convertible bond and the underlying bond remains outstanding until maturity. In other words, the exercising of the embedded option portion does not extinguish the bond portion.

In another embodiment of the present invention, the embedded option portion can be partially net settled. When being partially net settled, the bond according to the present invention settles the embedded option portion for a certain percentage of the net amount of the difference between the early exercise value and the value of the stock at the time of the exercise. For example, the holder of the bond can choose to settle only 50% of the value of the stock at the time of exercise, and leave the remaining 50% of the value for settlement at a later date. With this option, only a portion of the embedded option is extinguished, and the remaining portion is available for settlement at a later date. Therefore, only a percentage of the embedded option portion is extinguished in return for a smaller number of shares than a traditional convertible bond, the remaining portion of the embedded option remains outstanding until another trigger event occurs, and the underlying bond remains outstanding until maturity. Similar to the other embodiments, the partial exercising of the embedded option portion does not extinguish the bond portion.

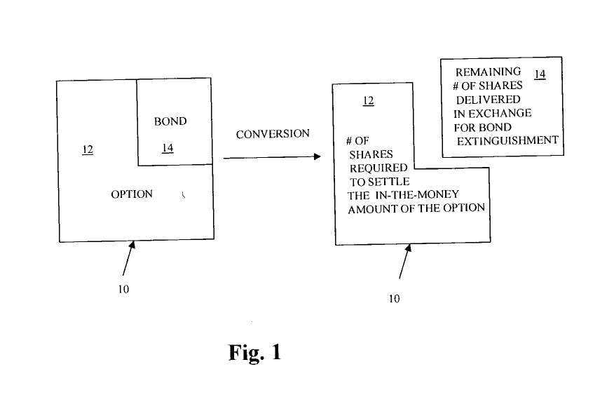

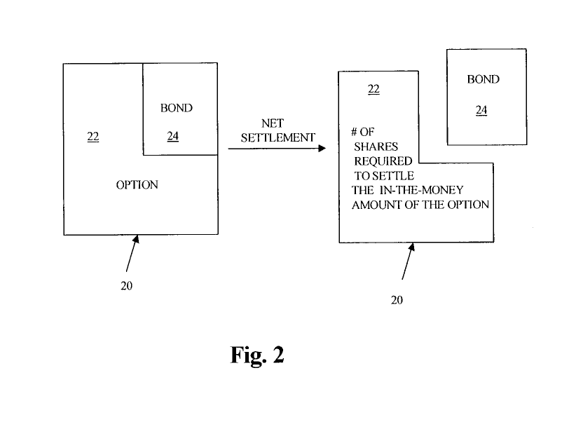

FIG. 2 illustrates the conversion of the contingent convertible bond 20 of the present invention. At issuance, the bond 20 includes an embedded option portion 22 and a bond portion 24. Upon exercising of the embedded option portion 22, the option portion 22 is converted into the number of shares required to settle the “in-the-money” portion of the embedded option 22 (e.g., the difference between the option (early exercise) price and the current price of the stock). Unlike a traditional convertible bond as illustrated in FIG. 1, though, the bond portion 24 is undisturbed (i.e., is not extinguished) and remains outstanding until the maturity of the bond portion 24.

The contingent convertible financial instrument according to the present invention preferably has no early conversion rights or put options for the investor. Similarly, there are preferably no call options for the issuer (other than a possible “tax call” described in greater detail below). Also, the financial instrument of the present invention preferably has an equity content worth at least about 35% of the proceeds or greater, most preferably about 65%. Accordingly, the present invention is designed to take maximum advantage of contingent interest rules, and is more efficient after tax cost of capital for the issuer than common stock or any other high equity content security.

The overall objective of the present invention for the issuer is to prevent early conversion (and bond extinguishment) and keep debt outstanding for an optimal economic time period and to achieve a net funding advantage over the longest period of time. If there are no puts, no calls and a rising target value, the comparable yield is typically the straight debt rate of the bond over the life of the bond (e.g., the 30 year straight debt rate for a 30 year bond). The overall objective of the present invention is to give equal or greater value to the holder of the instrument for early exercise than in a typical conversion and to provide the holder a higher claim in bankruptcy than a full conversion (i.e., bond portion is still a debt claim).

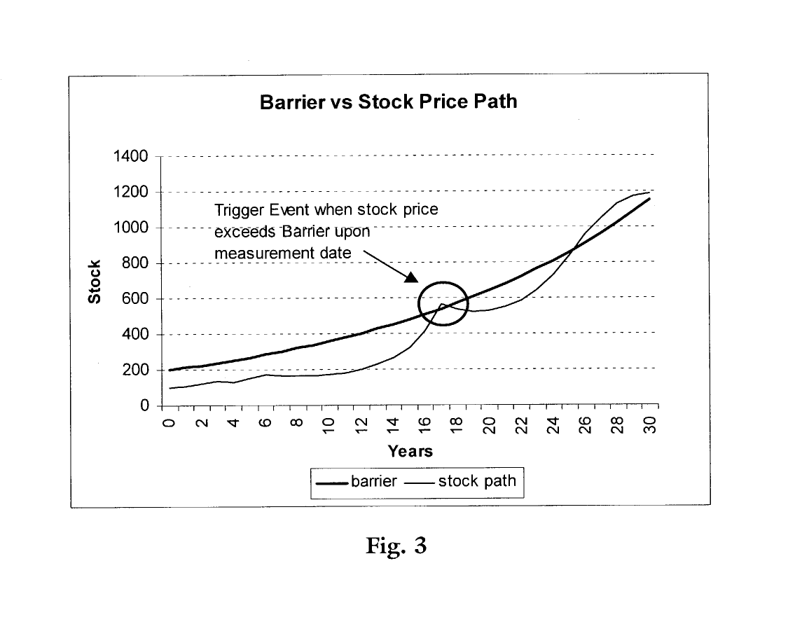

In structuring the contingent convertible bond according to the present invention, the target value is first established. Preferably, the target value at any point during the life of the bond is defined by a barrier level that is established by balancing an issuer's desire to maximize tax benefits and desire to raise proceeds by offering an attractive financial instrument to holders. As shown with the example in FIG. 3, the barrier level is a set percentage increase of 6% of the barrier level from the previous year, and is applied across the life of the bond (from years 0 to 30). The value of the barrier level at any given point in time represents the target value at that point within the life of the bond. Although FIG. 3 shows the barrier level as being a percentage function, it is possible to calculate and apply a barrier level other than percentage, such as for example, exponential, linear, flat, declining, variable, etc.

The reaching of the target value is preferably defined upon the happening of a trigger event. Upon the happening of this trigger event, holders of the bonds of the present invention are given an opportunity to exercise the embedded option so as to receive a payment. Typically, the holders are given a certain number of trading days within which to exercise the embedded option after the happening of the trigger event. If the embedded option is not exercised within the provided number of trading days, the opportunity to exercise the embedded option is preferably lost, and dividend pass through payments, if any, are truncated. Practically speaking, holders will generally leave standing orders with their brokers for exercise of the embedded option if such events occur.

In one embodiment of the present invention, a trigger event may occur if the average trading price of the issuer's common shares equals or exceeds the barrier level for a period of time preceding a base coupon payment period. The happening of such a trigger event is shown in FIG. 3.

Preferably, the bond is structured such that if a holder fails to exercise the embedded option upon the happening of the trigger event, the holder has relinquished all rights to convert the embedded option portion into common shares at the maturity date upon the trigger event. Alternatively, the bond could be structured to automatically cause the cancellation of the convertibility option at maturity while causing the automatic early net settlement.

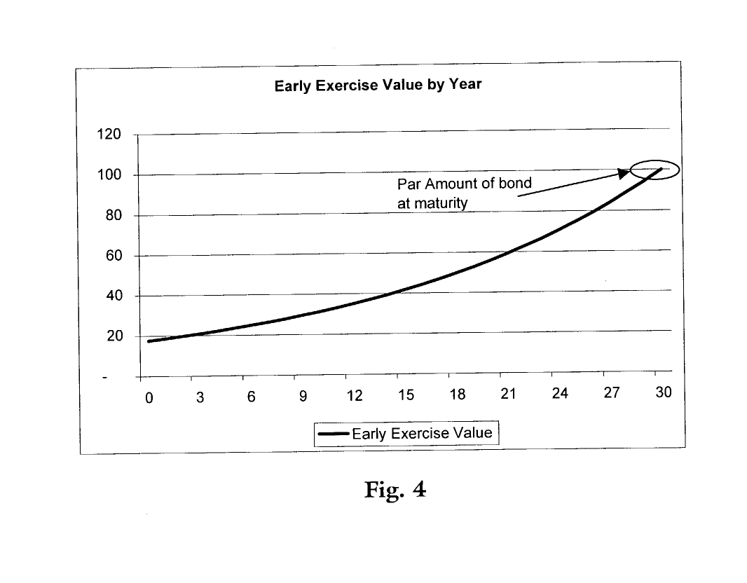

In the preferred embodiment, the net payment due to the holder in shares of stock upon exercise of the embedded option is calculated by multiplying the stock price at the time of exercise by a conversion ratio and then subtracting the early exercise value to arrive at a net settlement amount. The early exercise value may be a constant or a fixed schedule or a calculated schedule. An example of the early exercise value over the life of the financial instrument of the present invention is shown in FIG. 4. Preferably, and as shown in FIG. 4, the early exercise value is lower than the par amount of the bond until the maturity date is reached. The conversion ratio can be set as the issue price of the bond divided by the conversion price, or it can be set as the number of shares underlying the bond. The conversion ratio may be adjusted by the issuer for any or all of the following reasons typical of convertible instruments:

(a) dividends or distributions payable in shares of the issuer's stock;

(b) subdivisions, combinations and reclassifications of the issuer's stock;

(c) distributions to all holders of common stock of rights, warrants or options entitling them to buy shares below the market price; and

(d) distribution to all holders of common stock of non-cash distributions (i.e., assets, debt, securities, but generally excluding cash distributions for dividends subject to dividend indexed payments), unless such value exceeds a set percentage of market value of the stock.

The early exercise value may be calculated by dividing the initial par value or issue price by a discount factor. The discount factor is generally defined as:

(1+comparable yield)^{years remaining to maturity}. (1)

The comparable yield is generally established at issuance of the bond and is disclosed in the tax section of the documentation accompanying the bond.

Thereafter, the net settlement amount is divided by the stock price at the time of exercise of the embedded option portion to arrive at the number of shares to be received by the holder. Upon receipt of the shares after exercising the embedded option, the holder may then convert the shares to cash through any known trading transaction.

Additionally, the early exercise value may be a constant value of par, and upon the happening of the trigger event, the bond of the present invention may be structured such that the holders may also receive a payment (a bonus coupon) equal to a scheduled amount of:

Par−(Par/(1+comparable yield)^{time remaining to maturity}). (2)

Such scheduled amount payments may be made either in cash or in shares of stock of the issuer based on the average trading price.

Similar to traditional contingent convertible debt instruments, the contingent convertible bond of the present invention may include provisions for coupons. The bond can be designed to have coupons payable at regular intervals during the life of the bond, such as semi-annual coupons payable every six months. The coupons may be fixed, floating or a combination thereof. The bond may also be designed as a zero coupon bond, wherein there is one coupon payment due at maturity of the bond.

The bond may also be structured to have a dividend indexed coupon. A dividend indexed coupon is a dividend payment in an amount equal to any dividends paid on the shares of the issuer's common stock. This amount generally will accrue and be payable to holders of the bond as of the record date of a common stock dividend and payable when any common dividend is paid. Such payments may begin immediately or may be contingent upon time or other factors.

As stated above, the contingent convertible bond according to the present invention generally does not include any call rights for the issuer. However, in one embodiment of the present invention, the bond may be structured to include provision for a call. With a call, an issuer may redeem the bond for cash if an event occurs (e.g., tax motivated call, call if stock price rises above a stated threshold). For a tax call, a tax event is generally defined as meaning the actual or proposed enactment or issuance of any law, regulation, court decision, ruling, or other administrative pronouncement, or any other similar legal development, that has occurred after the issuance of the instrument, wherein there is more than an insignificant chance that the amount or timing of the tax benefits that are intended to be realized by the issuer with respect to the instrument has been or will be materially affected.

As stated above, the bond according to the present invention generally does not include any put options for the holder of the bond. However, the bond may be structured such that the holder of the bond can put the bond to the issuer a) on certain specified dates and prices and/or b) if there is a change in control or consolidation of the issuer. In other words, if the issuer is a party to a merger/consolidation to which all its common stock would be converted into cash, property or securities, then the bond may also be settled in such cash, properties or securities. If such a merger/consolidation or other “change in control event” occurs, holders may put the bond to the issuer for the bond's principal amount plus accrued base coupon interest.

A “change in control event” is generally defined as meaning (a) if any person acquires more than 50% of the voting power of the issuer; and/or (b) any merger in which the issuer's holders would represent less than a majority of the continuing shareholders by vote, although other definitions are also feasible.

If the maturity date is reached without exercise of the embedded option, and provided the trigger event has not occurred, the holders of the bonds may exchange their bonds for a conversion payment. The conversion payment may be made as follows:

(a) if the value of the stock is below the initial par amount of the bond (i.e., “out of the money”), then the holders of the bonds may receive a cash payment equal to early redemption amount of the bond;

(b) if the average closing price of the issuers shares over the final coupon period (i.e., the final average price) exceeds a certain percentage of the conversion price, such as 150% of the conversion price, the holders will have the option to entirely convert the bonds into a certain number of shares per bond (i.e., the bond may only be settleable entirely in shares); or

(c) if the final average price is above the conversion price, but below the certain percentage (150%, for example) of the conversion price, holders may convert their bonds in exchange for (1) the net amount of shares due to settle the embedded option portion and (2) cash equal to the par amount due at maturity. The net amount of the embedded option portion may be payable in cash or shares at the issuers discretion.

The bond may be structured such that it is convertible prior to maturity if (1) the bond is called for redemption or (2) if the issuer is subject to specified corporate actions. The specified corporate actions may include (a) if the issuer elects to distribute common holder rights, warrants or options; (b) if the issuer elects to distribute cash, debt, securities or assets having a value exceeding a set percentage (i.e., 10%, for example) of the current market value of issuer shares; (c) if the issuer has a rating below an established investment grade; and/or (d) each coupon period in which the average trading price of the issuer's common stock was at or below a certain percentage (i.e., 80%, for example) of the initial price for specified period of days prior to the base coupon period. Preferably, the bond is structured so as to remain immediately convertible as long as such condition(s) exist. If such condition(s) is/are cured, and no further conditions exist, all unconverted bonds preferably revert back to their initial conditions.

An example of a bond structured according to the preferred embodiments of the present invention will now be described. In this example it is assumed that the bond is a 30 year bond; the bond issuer's share price at issuance is valued at $100; the stock pays no dividends; the stock price at year 15 is 461% greater than the initial price, or $461; the comparable yield is 8.00% and the conversion ratio is 1 share to 1 share. Given the above, if the embedded option portion is exercised in year 15, then the number of shares due the holder upon exercise is 0.931 and is calculated as follows using equation (2) above:

| | | |
|---|---|---|
| | Current Stock Price Year 15 | $461 |
| × | Conversion Ratio | 1 |
| − | Present Value of Par [100/(1 + 8%)^{15]} | $32 |
| = | Net Settlement Amount | $429 |
| ÷ | Current Stock Price | $461 |
| = | Number of Shares Due Holder | 0.931 |

Assuming that this bond has a projected payment in year 30 of $621, then the tax recapture for the bond issuer of this bond if the embedded option portion is exercised in year 15 is calculated as follows:

| | | |
|---|---|---|
| | Prior Projected Payment at Year 30 | $621 |
| − | New Projected Payment at Year 30 | $100 |
| = | Negative Adjustment | $521 |
| ÷ | Discount Factor (1 + 8%)¹⁵ | 3.17 |
| = | Present Value of Recapture in Year 15 | $164 |

To calculate the tax deduction for the issuer of the bond upon exercise of the embedded option in year 15, the present value of recapture in year 15 is subtracted from the net payment. With the example above, $429−$164=$265 tax deduction. The value of the tax deduction in year 15 is calculated by multiplying the tax deduction by the tax rate. With the example above, and assuming a 40% tax rate, the $265 tax deduction multiplied by the 40% tax rate results in a $106 value of the tax deduction in year 15.

The contingent convertible financial instrument according to the present invention is designed to prohibit early conversion until an issuer's stock price trades above the barrier level so as to maximize the potential of receiving annual tax deductions at the comparable yield and keep the low cost funding advantage of the underlying bond outstanding. The preferred embodiment of the contingent convertible financial instrument of the present invention is designed to provide: a) early exercise of the instrument only in circumstances that are beneficial to the issuer while continuing to provide benefits to the issuer by allowing the issuer to receive annual tax deductions on the continuing bond portion after exercise of the embedded option until the maturity of the instrument; and b) the holders of the instrument with a value package upon early exercise at least as great as in a traditional conversion and a higher seniority claim in bankruptcy (via the continuing bond).

The contingent convertible financial instrument of the present invention can be easily modeled by holders with minimal modifications to their traditional convertible models. This operates to minimize the discount to the theoretical value the holders will offer to purchase the instrument.

As such, a bond structured according to the preferred embodiments of the present invention increases the potential after tax benefit to an issuer by using a combined embedded option and trigger event and a higher comparable yield. Accordingly, the contingent convertible financial instrument according to the present invention provides superior benefits to traditional contingent convertible debt instruments by providing an issuer with: (1) deductions at its comparable yield whether the instrument is exercised prior to maturity or remains unexercised until maturity; and (2) an additional deduction if the instrument is exercised prior to maturity.

The unique embedded option of the present invention addresses the problem of traditional contingent interest convertible instruments wherein tax benefits are reduced if there is early conversion of the bond by the holder and if the stock price does not equal or exceed the “projected” level at maturity. The preferred embodiment of the present invention addresses these problems by (1) decreasing the concern of early conversion by a holder of the bond because there is a prohibition on early conversion or truncation (i.e., there are no put options); and (2) decreases the concern of deductions being rebated if the stock price does not equal or exceed the “projected” level at maturity because, if the trigger event occurs and the embedded option is exercised, no deductions will be rebated due to subsequent stock price decline or failure of stock price to reach the “projected” level at maturity.

With respect to the United States, securities laws recognize three basic procedures by which securities may be sold: (1) offerings registered with the SEC that may be sold to the public generally; (2) private placements of securities that are not registered with the SEC and may only be sold to accredited investors and other sophisticated investors; and (3) Rule 144A offerings which are not registered with the SEC and may only be sold to Qualified Institutional Buyers (QIBs) and later resold to QIBs. The contingent convertible financial instrument according to the present invention may be structured, offered and sold under any of these basic procedures. It will also be evident to one skilled in the art how the present invention may be adapted to comport with the laws of other countries.

Accordingly, the contingent convertible financial instrument according to the present invention can be issued by any company, developed by a derivatives dealer, and purchased by individuals, corporate entities, investment funds, municipalities or governments.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A convertible financial instrument comprising:
a bond portion redeemable at a maturity date; and
an embedded option portion exercisable upon reaching a target value, said embedded option portion being exercisable for shares of stock in said entity issuing said convertible financial instrument in an amount equal to the difference between an early exercise value and a value of said stock on the date the embedded option is exercised, wherein the exercising of said embedded option portion does not extinguish said bond portion.

2. The convertible financial instrument according to claim 1, wherein said bond portion remains outstanding until maturity upon the exercising of said embedded option portion.

3. The convertible financial instrument according to claim 1, wherein said embedded option portion is partially exercisable for a certain percentage of a net amount of the difference between said early exercise value and said value of said stock on the date said embedded option is exercised such that only a portion of said embedded option is extinguished, and a remaining portion is available for exercise at a later date.

4. The convertible financial instrument according to claim 3, wherein said remaining portion of said embedded option remains outstanding until another trigger event occurs.

5. The convertible financial instrument according to claim 1, wherein said embedded option portion is exercisable before said bond portion reaches said maturity date.

6. The convertible financial instrument according to claim 1, wherein said bond portion does not include an early conversion right.

7. The convertible financial instrument according to claim 1, wherein said bond portion does not include a put option.

8. The convertible financial instrument according to claim 1, wherein said bond portion does not include a call option.

9. The convertible financial instrument according to claim 1, wherein said financial instrument has an embedded equity content of at least 35% of a par value of said financial instrument.

10. The convertible financial instrument according to claim 1, wherein said target value is defined by a barrier level applied across the life of said bond portion.

11. The convertible financial instrument according to claim 10, wherein said barrier level is one of a flat barrier level, an escalating barrier level, a declining barrier level and a variable barrier level.

12. The convertible financial instrument according to claim 10, wherein said barrier level is calculated as a function of an initial value of said stock.

13. The convertible financial instrument according to claim 12, wherein said barrier level is at least about 2 times said initial value of said stock.

14. The convertible financial instrument according to claim 1, wherein the reaching of said target value is defined upon the occurrence of a trigger event.

15. The convertible financial instrument according to claim 14, wherein said trigger event occurs if an average trading price of said shares of stock equals or exceeds said barrier level for a specified time period.

16. The convertible financial instrument according to claim 15, wherein said specified time period is a set period of trading days.

17. The convertible financial instrument according to claim 15, wherein said specified time period is a set period of trading days preceding a base coupon payment period.

18. The convertible financial instrument according to claim 14, wherein said bond portion is structured such that upon the occurrence of said trigger event, the right to convert said embedded option portion into shares of said stock at said maturity date is relinquished and dividend pass through payments, if any, are truncated.

19. The convertible financial instrument according to claim 14, wherein said bond portion is structured such that upon the occurrence of said trigger event, there is a mandatory conversion and an automatic net settlement of said embedded option portion into shares of said stock, and dividend pass through payments, if any, are truncated.

20. The convertible financial instrument according to claim 1, wherein a net payment in said shares of stock upon said exercise of said embedded option portion is calculated by multiplying a stock price at the time of said exercise by a conversion ratio, subtracting the early exercise value and then dividing by said stock price at the time of said exercise.

21. The convertible financial instrument according to claim 20, wherein said early exercise value is a present value of par that remains outstanding in said bond portion.

22. The convertible financial instrument according to claim 1, further comprising a contingent conversion feature which, upon the occurrence of a specified event, allows a full conversion of said bond portion into said shares of stock in said entity issuing said convertible financial instrument.

23. The convertible financial instrument according to claim 22, wherein said specified event occurs before said maturity date of said bond portion.

24. The convertible financial instrument according to claim 22, wherein said specified event occurs before said bond portion reaches said target value.

25. The convertible financial instrument according to claim 1, wherein said bond portion includes at least one coupon redeemable by a purchaser of said bond portion.

26. The convertible financial instrument according to claim 25, wherein said bond portion includes a plurality of coupons redeemable at set intervals.

27. The convertible financial instrument according to claim 26, wherein said set intervals are every six months.

28. The convertible financial instrument according to claim 25, wherein said bond portion includes one coupon redeemable at said maturity date of said bond portion.

29. The convertible financial instrument according to claim 1, wherein said bond portion includes a call option.

30. The convertible financial instrument according to claim 29, wherein said call option is exercisable upon the happening of a tax event.

31. The convertible financial instrument according to claim 30, wherein said tax event is an event that effects the tax benefits of said bond portion.

32. The convertible financial instrument according to claim 29, wherein said call option is exercisable only prior to the reaching of said target value.

33. The convertible financial instrument according to claim 1, wherein said shares of stock are shares of common stock in said entity issuing said convertible financial instrument.

34. The convertible financial instrument according to claim 1, wherein if said maturity date is reached without exercise of said embedded option portion, said bond portions may be exchanged for a conversion payment.

35. A method of providing a convertible financial instrument, the method comprising:
issuing a bond having an embedded option, said bond being redeemable at a maturity date; and
receiving payment in return for a sale of said bond,
wherein said embedded option is exercisable upon the reaching of a target value for shares of stock in an entity issuing said bond in an amount equal to the difference between an early exercise value and a value of said stock on the date the embedded option is exercised, and said exercising of said embedded option does not extinguish said bond.

36. The method of providing a convertible financial instrument according to claim 35, wherein said bond remains outstanding until said maturity date after the exercising of said embedded option.

37. The method of providing a convertible financial instrument according to claim 35, wherein said embedded option portion is partially exercisable for a certain percentage of a net amount of the difference between said early exercise value and said value of said stock on the date said embedded option is exercised such that only a portion of said embedded option is extinguished, and a remaining portion is available for exercise at a later date.

38. The method of providing a convertible financial instrument according to claim 37, wherein said remaining portion of said embedded option remains outstanding until another trigger event occurs.

39. The method of providing a convertible financial instrument according to claim 35, wherein said embedded option is exercisable before said bond reaches said maturity date.

40. The method of providing a convertible financial instrument according to claim 35, wherein said target value is defined by a barrier level applied across the life of said bond.

41. The method of providing a convertible financial instrument according to claim 40, wherein said barrier level is one of a flat barrier level, an escalating barrier level, a declining barrier level and a variable barrier level.

42. The method of providing a convertible financial instrument according to claim 40, wherein said barrier level is calculated as a function of an initial value of said stock.

43. The method of providing a convertible financial instrument according to claim 42, wherein said barrier level is at least about 2 times said initial value of said stock.

44. The method of providing a convertible financial instrument according to claim 35, wherein the reaching of said target value is defined upon the occurrence of a trigger event.

45. The method of providing a convertible financial instrument according to claim 44, wherein said trigger event occurs if an average trading price of said shares of stock equals or exceeds said barrier level for a specified time period.

46. The method of providing a convertible financial instrument according to claim 45, wherein said specified time period is a set period of trading days.

47. The method of providing a convertible financial instrument according to claim 45, wherein said specified time period is a set period of trading days preceding a base coupon payment period.

48. The method of providing a convertible financial instrument according to claim 44, further comprising, structuring said bond such that upon the occurrence of said trigger event, the right to convert said embedded option into said shares of stock at said maturity date is relinquished and dividend pass through payments, if any, are truncated.

49. The method of providing a convertible financial instrument according to claim 44, further comprising, structuring said bond such that upon the occurrence of said trigger event, there is a mandatory conversion and an automatic net settlement of said embedded option portion into said shares of said stock, and dividend pass through payments, if any, are truncated.

50. The method of providing a convertible financial instrument according to claim 35, further comprising paying a coupon to a holder of said bond.

51. The method of providing a convertible financial instrument according to claim 35, wherein said bond is structured such that said shares of stock are shares of common stock in said entity issuing said bond.

52. The method of providing a convertible financial instrument according to claim 35, further comprising exchanging said bond for a conversion payment if said maturity date is reached without exercise of said embedded option.

53. A method of trading a contingent convertible financial instrument, the method comprising:
providing a trading platform for a bond having an embedded option, said bond being redeemable at a maturity date;
facilitating a trade of said bond on behalf of an entity issuing said bond; and
receiving a fee for said trade,
wherein said embedded option is exercisable upon the reaching of a target value for shares of stock in said entity issuing said bond in an amount equal to the difference between an early exercise value and a value of said stock on the date the embedded option is exercised, and said exercising of said embedded option does not extinguish said bond.

54. The method of trading a contingent convertible financial instrument according to claim 53, further comprising facilitating said exercise of said embedded option in return for a fee.

55. The method of trading a contingent convertible financial instrument according to claim 54, further comprising receiving an order to exercise said embedded option.

56. The method of trading a contingent convertible financial instrument according to claim 55, wherein said order is a standing order received upon the trade of said bond.

57. The method of trading a contingent convertible financial instrument according to claim 53, further comprising redeeming a coupon on behalf of a holder of said bond.

58. The method of trading a contingent convertible financial instrument according to claim 53, further comprising exchanging said bond for a conversion payment on behalf of a holder of said bond if said maturity date is reached without exercise of said embedded option.

59. A method of using a contingent convertible financial instrument, the method comprising:
purchasing a bond having an embedded option, said bond being redeemable at a maturity date; and
exercising said embedded option upon the reaching of a target value for shares of stock in an entity issuing said bond in an amount representing the difference between an early exercise value and a value of said stock on the date said embedded option is exercised,
wherein said exercising of said embedded option does not extinguish said bond.

60. The method of using a contingent convertible financial instrument according to claim 59, wherein said embedded option is exercised before said bond reaches said maturity date.

61. The method of using a convertible financial instrument according to claim 59, wherein said embedded option portion is partially exercised for a certain percentage of a net amount of the difference between said early exercise value and said value of said stock on the date said embedded option is partially exercised such that only a portion of said embedded option is extinguished, and a remaining portion is available for exercise at a later date.

62. The method of using a convertible financial instrument according to claim 61, further comprising exercising said remaining portion of said embedded option upon the reaching of a subsequent target value for said shares of stock in said entity issuing said bond in an amount representing the difference between said early exercise value and a value of said stock on the date said remaining portion of said embedded option is exercised.

63. The method of using a contingent convertible financial instrument according to claim 59, further comprising redeeming at least one coupon during the life of said bond.

64. The method of using a contingent convertible financial instrument according to claim 59, further comprising redeeming coupons at set intervals during the life of said bond.

65. The method of using a contingent convertible financial instrument according to claim 59, further comprising redeeming one coupon at said maturity date of said bond.

66. The method of using a contingent convertible financial instrument according to claim 59, further comprising exchanging said bond for a conversion payment if said maturity date is reached without exercise of said embedded option.
